(19) United States
(12) Patent Application Publication
(10) Pub. No.: US 2005/0217369 A1
(43) Pub. Date: Oct. 6, 2005

(54) Vessel with integrated liquid level sensor

(76) Inventors: Kenneth W. Holappa, Hobe Sound, FL (US); Lin Mu, Hobe Sound, FL (US)

Correspondence Address: DUANE MORRIS, LLP;IP DEPARTMENT, ONE LIBERTY PLACE, PHILADELPHIA, PA, 19103-7396, US

(21) Appl. No.: 10/813,816

(22) Filed: Mar. 31, 2004

(51) Int. Cl. G01F 23/00

(52) U.S. Cl. 73/304 C

(57) ABSTRACT

A capacitive liquid level sensor is integrated with a drinking vessel or the like, and provides a sensory output signal having a characteristic that varies as a function of liquid level in the vessel. The vessel can have a hollow wall with conductive plates placed or affixed on a back surface of an inner wall panel of a hollow wall or protected by a handle. The plates form a capacitor for which liquid displacing air in the vessel provides at least part of the dielectric. A timing circuit is responsive to the capacitance of the plates, which changes when the liquid level displaces air from around or between the plates and changes the effective dielectric constant. The circuit can produce a preferably non-visual signal that varies over a range of liquid levels, or can change when the level passes a threshold level.

### FIELD OF THE INVENTION

The invention relates to electronic liquid level sensors and to aids for the visually impaired. A capacitive liquid level sensor and audible indicator are integrated with a cup or other vessel for carrying liquid, especially in a hollow wall of the vessel and adjacent to a handle.

### BACKGROUND

Visually impaired individuals rely on non-visual liquid level sensing techniques for information on the liquid level in vessels such as cups, pots, measuring cups, coffee and other carafes, jugs, pitchers, and other containers. It may be advantageous at times to determine the static level of a liquid in a vessel, and at times to monitor the level of liquid dynamically, e.g., to follow progress while pouring liquid into the vessel. In the case of a changing level, it is advantageous periodically or continuously to determine the current level of liquid in the vessel, to prevent overflowing and spillage. When seeking to measure out a specific quantity or to determine that the liquid has reached a predetermined level while filling the vessel, it is helpful to obtain an indication immediately.

Certain electronic liquid level sensor/indicators are available to assist the visually handicapped by providing non-visual signals. A measurement based on electrical conductivity may be possible by extending spaced electrodes to a predetermined level and sensing for a drop in resistance when rising liquid reaches the level of the electrodes and closes a circuit including the electrodes. Another electrical property that can be used in a similar way is to sense for a difference in dielectric properties of the material between and adjacent to spaced electrodes. Such properties are distinct for liquid as compared to air.

Capacitive sensors are used in industry to sense the presence of material in bins and other large receptacles. The technique is typically to establish a changing potential difference between capacitor plates, and to detect the difference in charge or current levels involved. Stated another way, a change in capacitance may occur when a material is inserted between conductive plates, in lieu of air, and alters the impedance of a circuit including the plates.

The material in the container may be electrically conductive, but advantageously the sensor responds to the dielectric properties of the material rather than conductivity. Therefore, in a capacitive sensor, the two conductive plates may be insulated from the material as well as spaced from one another. On the other hand, for maximizing the electrical difference between situations, i.e., air versus material being disposed in the container at the level of the sensor, it is advantageous if the capacitor plates are close to or even submerged in the zone that contains the material.

Pairs of vertically short plates could be located at incrementally higher levels, each pair of plates effectively detecting the presence of material at or above the level of the associated plates. Such “short” plates can be separately monitored by threshold detection techniques responsive to capacitance as individual level detectors. Alternatively, taller plates can be used (or an array of short plates can be coupled in parallel), in which case the capacitance of the arrangement varies over a range as liquid or other material filling the container reaches a progressively higher level between the upper and lower limits of the plates or the array. The range of capacitance can be discriminated within the range and used as the input to an indicator circuit. All of these situations can be the basis of a detector, but there are practical challenges.

The difference in capacitance that occurs when liquid rather than air is the primary applicable dielectric material, can be detected in various ways that are effectively capacitance measurements. The capacitance can affect the charging rate of the plates through a series resistance, or the extent to which higher or lower frequency components are coupled through a tuned circuit, etc. Timing and/or threshold level circuits can be used to determine when a given condition is reached. In order to be useful as an indicator for the visually impaired, an output signal is generated that is perceivable in a non-visual manner, such as audibly or by vibration or the like.

Examples of capacitive liquid level indicating devices are disclosed in U.S. Pat. Nos. 5,406,803 and 6,164,132, for example. Liquid level sensors available to assist the visually impaired in determining changing liquid levels include the “Vibrating Liquid Level Indicator,” the “Sensa Cup Level Indicator MK 111,” and the “Easy Say Stop Liquid Level Indicator, available on the Web, for example, from Maxi-Aids, Inc., Farmingdale, N.Y. (http://www.maxiaids.com/). These products generally include devices that hang on the rim of a cup, and as so positioned, place spaced electrodes in the volume to be occupied by the liquid, which electrodes become immersed as the cup is filled to their level. A “Talking Liquid Jug” from the same company has a vessel removably carried on a base receptacle that has volume measurement and announcement functions.

It would be advantageous to provide an electronic liquid level indicator that is integrated with a liquid containing vessel, is effective and inexpensive, and is particularly useful for the visually impaired.

### SUMMARY OF THE INVENTION

According to an inventive aspect, a liquid sensing apparatus has a liquid level sensor and circuits responsive to the sensor for generating an output signal indicative of the liquid level, all integrated into a vessel that is to contain the liquid. The apparatus and method of the invention may be advantageously used by the visually impaired and the visually and hearing impaired.

In one embodiment, a liquid sensing apparatus comprises a liquid carrying vessel with a wall bounding the liquid carrying volume, and the wall forms an at least partly electrically insulating barrier. The wall can be a hollow structure that also provides a fluid tight receptacle for the electrical components (i.e., wholly or partly disposed in the hollow). In alternative embodiments, the capacitive plates can comprise various conductive materials or compositions, embedded or incorporated in, or printed or adhered onto the surfaces, or otherwise integrated into or on the walls of the container. Preferably the plates are electrically insulated from the inner surfaces defining the liquid confinement volume. In a particularly advantageous embodiment, the plates are associated with a vessel handle, and are mounted so as to respond primarily to capacitance differences caused by material in the vessel, as opposed to differences from the user's hand when grasping the handle or grasping the cup from under the handle.

A variety of circuitry arrangements can be used to discriminate for material (e.g., liquid) in the vessel at a particular level, and examples are discussed hereinafter. The components provide a preferably non-visual sensory output that indicates a liquid level condition within the vessel, for example indicating detection of liquid through the inner wall surface at least at one predetermined threshold level, and alternatively providing an indication over a range that the user, at least with minimal experience, can readily interpret.

In an exemplary embodiment, a vessel wall has an inner surface defining the liquid holding volume, and an other surface that can be the opposite side of the same wall, but also can be a different surface, e.g., associated with an annularly spaced wall in a hollow wall arrangement. The vessel wall associated with the inner surface comprises an electrically insulating material. An array of two or more paired conductive plates are disposed on said other surface and are covered, spaced from or similarly protected against influence or contact with the user's hand, by a handle affixed to the liquid containing vessel. The handle can carry at least certain of the associated electronic components or space can be provided in a hollow wall or hollow bottom or elsewhere. The handle can be structured to space and/or insulate the plates from influence from the user's hand. In an embodiment with inner and outer wall panels separated by an air gap, the plates can be placed on the outside of the inner panel and thus separated from such influence by the air gap.

The electronic components include a capacitor comprising two or more paired conductive plates. The plates can be arranged in various configurations provided that there is a duality whereby at least certain plates or groups are electrically opposed to at least certain other plates or groups. The electronic components respond to differences in electrical properties, i.e., capacitance, and produce a sensory output that is indicative of a liquid level within the liquid containing vessel.

The invention concerns both apparatus and methods for sensing liquid level, by passage of a threshold or by discrimination for one or more parameters over a range. The method includes providing a container or vessel with capacitive plates, preferably between or against container walls, for sensing a liquid defining a liquid level in the vessel and responding to a capacitance parameter that varies with the liquid level. The response can generate a sensory output that is indicative of the liquid level.

According to another aspect, a method for sensing liquid level includes providing a vessel including a wall with an inner surface and an outer surface separated by an electrical insulating material or by an air gap (or both). A duality of conductive plates is disposed on the outer surface and is covered over at or adjacent to a handle member affixed to the liquid containing vessel, preferably integrally or permanently, but optionally as a detachable handle, and having electronic components therein. The electronic components include at least one capacitor resulting from the duality of conductive plates and providing a detectably variable capacitance parameter that changes as a function of liquid level in the vessel. A sensory output signal is provided with a characteristic that varies with the liquid level as an indicator of the level of liquid in the vessel.

### BRIEF DESCRIPTION OF THE DRAWING

The invention can be understood from the following detailed description when read in conjunction with the accompanying drawing. It is emphasized that, according to accepted practice, the features of the drawing are not necessarily to scale and may be shown arbitrarily expanded or reduced for clarity. The same numerals are used to denote the same features throughout the specification and drawings, wherein:

FIG. 1 is a cross-sectional view of an exemplary liquid sensing apparatus according to an embodiment of the invention;

FIG. 2 is a cross-sectional top view;

FIG. 3 is a side perspective view of an alternative liquid sensing apparatus according to the invention;

FIG. 4 is a top, cross-sectional view of the exemplary liquid sensing apparatus shown in FIG. 3;

FIG. 5 is an exemplary circuit diagram for an exemplary liquid sensing apparatus of the present invention;

FIG. 6 is an exploded perspective view of an exemplary liquid sensing apparatus of the present invention; and

FIG. 7 is a perspective assembled view of the liquid sensing apparatus shown in FIG. 6.

### DETAILED DESCRIPTION

The invention provides a liquid containing vessel with electronics for detecting liquid level, the electronics advantageously being wholly integrated into the liquid containing vessel. The electronics include conductive structures defining the plates of a capacitor. This capacitor can be configured in several ways, each having an effective set of at least two plates or electrodes defining a gap or encompassing a zone of influence. The vessel is to contain liquid that displaces air in the gap or zone when the liquid is disposed in the vessel. This zone of influence or detection includes the space linearly between the plates and the adjacent volume to the extent that the capacitance of the duality of opposed conductive plates is influenced and a change in capacitance is detectable.

The plates of the resulting capacitor, responsive to contents of the vessel, are coupled in an electronic circuit that generates a sensory output signal with two or more distinct states, or with a continuously variable output parameter, so as to indicate a liquid level in the vessel as determined by a level or change in capacitance.

The sensory output signal can have one or more characteristics that vary discretely or continuously over a range, as either the liquid level or the capacitance reaches one or more level or capacitance thresholds, or so as to vary continuously in a range. The invention may be used to measure a standing liquid level in a vessel or to measure a dynamically changing liquid level.

The sensory output signal advantageously is provided wholly or partly as a signal or indication that is perceptible by non-sighted users. For example an audible sound such as a series of beeps or a voice, which is indicative of liquid level, may be provided. In another exemplary embodiment, the invention may provide a sensory output signal that is perceivable by non-sighted users that are also hearing impaired. Vibration or other mechanical movement may provide such a sensory output signal.

According to another aspect, the sensory output signal has one or more characteristics that varies with liquid level, the output signal thereby indicating an assessment of current liquid level according to some criteria. For example, the liquid sensing apparatus may provide distinct or continuously varying signal characteristic in response sensed liquid levels over the full range of depth of the liquid containing vessel.

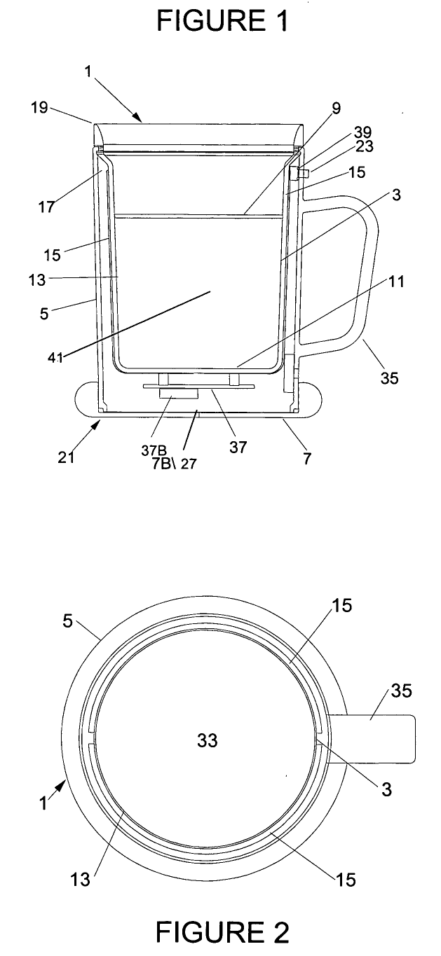

FIG. 1 is a side, cross-sectional view of an exemplary inventive liquid sensing apparatus. In FIG. 1, liquid containing vessel 1 may be a cup, a pot, a glass, a pitcher, a jug, a ladle, a measuring cup, a coffee or other carafe, or any of various other liquid-containing vessels. For brevity, liquid containing vessel 1 will be hereinafter referred to as cup 1 but such designation is for convenience and is not intended to limit the structure of the vessel to specific structural attributes, such as arguably befitting a cup more than another form of comparable vessel.

In the example shown, cup 1 is hollow, having two wall panels spaced by an air gap, each of which has an inner and outer side or surface. Accordingly, cup 1 includes an inner wall 3 defining an inner surface 11 bounding the liquid confining volume. Cup 1 also has an outer wall 5 with an outer surface 7 that defines the outside of the vessel and is typically grasped.

Conductive plates 15 can be formed on the innermost surface containing the liquid, but this is not preferred. The plates 15 as shown are mounted on a surface 13 that forms the back side of the inner wall 3, facing into the air gap space between the spaced walls 3, 5. In this way, the plates 15 are closely adjacent to the inner surface 11 bounding the liquid, but are insulated from the liquid and space from direct contact by the thickness of inner wall 3. The inner wall 3 preferably comprises plastic or glass or the like.

Various conductive materials such as aluminum, copper, conductive foils, coatings, suspensions of conductive particles, polymers, and various other metal or conductive compositions can be used to form all or part of conductive plates 15. As appropriate to the material used, conductive plates 15 may be formed integrally with the associated wall or attached or applied thereto. Techniques for providing two conductive plates on such a wall surface include, for example, electrostatic plating, chemical plating, etching, adhesion, painting or printing, and various other techniques. By locating conductive plates 15 in the gap between inner surfaces 11 and outer surfaces 7 in a hollow wall arrangement, specifically on the back side of the inner wall panel, the plates are close to the liquid containing area and are electrically insulated from the liquid, as well as insulated from and spaced from external influences such as the dielectric properties of the hand of a user who grasps the vessel.

In the exemplary embodiment shown in FIG. 1, conductive plates 15 extend over a height 31 substantially continuously from a lip area 19 to a bottom 21 of cup 1. This configuration is exemplary only. In other embodiments, conductive plates 15 may be shorter. Plural plate segments can be used, spaced vertically and operated separately or in parallel. Other variations also are possible for reasons that will become apparent.

In another exemplary embodiment, conductive plates 15 may extend below bottom portion 29 of inner wall 3. Certain electronic components also can be disposed in this area, between inner wall 3 and bottom panel 7 in a hollow bottom portion 21 of cup 1. The electronic components shown including electronic components 37B and 37S, which are shown schematically.

In the illustrated embodiment, inner wall 3 and outer wall 5 are spaced by a gap 17, which gap or space 17 is continued from the bottom portion 21 of the cup into an annular gap between cylindrical walls 3, 5, extending around the upper portion of the cup. See also FIG. 2. This arrangement is advantageous, but some of the advantages of the invention can be obtained without a gap, e.g., with walls 3 and 5 in contact or with the gap potted in with plastic or the like, etc. In another exemplary embodiment, instead of distinguishable walls 3 and 5, the sides of cup 1 may be a solid molded piece in which conductive plates 15 are embedded in an integrally molded piece. The plates and one or more of the electronic components 37 may be similarly embedded in a molded embodiment.

The electronic components 37, including electronic components 37B and 37S, operate in conjunction with conductive plates 15, which form a capacitor having a dielectric that is partly defined by liquid that displaces air in the cup when filled. The capacitor defined by plates 15 is coupled into an electrical circuit responsive to capacitance and thereby altered in operation by a change in dielectric parameters, as described below. A circuit controlling switch button 23 can be disposed on outer surface 7 for on/off or intermittent operation or to change modes of operation.

Cup 1 optionally includes a handle 35 and in the illustrative embodiment, control or button 23 is disposed above handle 35 for thumb contact. Button 23 and handle 35 may have different locations, but advantageously, button 23 is placed for easy access by a user's finger or other hand surface when the user holds or manipulates cup 1 via handle 35. Button 23 is mechanically associated with an electric on/off switch 39 which activates the electrical circuit. In an exemplary embodiment, button 23 may be a tactile-contact type push button. Possible button controls and on/off switch arrangements can include momentary contact, push-on/push-off, generation of a pulse, operation of a magnetic reed switch, etc.

The electrical circuit includes battery 37B which may be replaceable, such as through opening 27 formed in outer wall 5 of cup 1. Opening 27 may be a door, latch, removable plate or any other opening that allows removal and replacement of battery 37B. Inner wall 3 and therefore inner surface 11 comprises or is coated with an electrically insulating material so as to prevent shorting between plates 15, which are to function as the plates of a capacitor. The insulating material can comprise non-conductive plastic, glass or other mineral, ceramic, combinations of materials, etc. Outer wall 5 may be formed of various suitably durable materials and may also be an electric or substantially non-conductive material like the inner wall 3. In its included inner volume 33, cup 1 receives and retains liquids such as liquid 41, which by gravity assumes a liquid level 9.

FIG. 2 is a sectional plan view of cup 1 and shows inner wall 3, outer wall 5 and annular space 17. The two conductive plates 15 are electrically insulated from one another because inner wall 3 is formed of an insulating material. In the illustrated embodiment, FIG. 2 shows each of conductive plates 15 extending a substantial way (each approximately half way) around an inner circumference of cup 1. In other exemplary embodiments, the circumferential dimension, or width, of conductive plates 15 may be considerably less, particularly because much of the detectable electrical effects occur in the area where the plates 15 are in closest proximity. In one embodiment, each of conductive plates 15 comprises substantially a vertical strip having a narrow width with respect to the circumference of cup 1.

Returning to FIG. 1, switch 39 activates the electrical circuit responsive to button 23. In the illustrated example, one of the two conductive plates 15 is momentarily connected to a voltage or current source through a series resistor while the other conductive plate 15 is connected to ground. Of course the switched contacts could be placed anywhere in the circuit. The capacitor formed by plates 15 charges toward the applied voltage (e.g., the DC power supply or battery voltage) through a series resistor. The charging rate depends in part on the dielectric material of the capacitor. The dielectric material, plate dimensions, spacing and configuration, determine capacitance. The charging rate depends on the presence or absence of liquid in the cup 1.

In an exemplary embodiment, battery 37B powers the circuit including the conductive plates 15. Other suitable voltage or current sources may be used. When voltage is applied to the circuit, current through the series resistor charges the capacitor created by the two conductive plates 15 and the material between the plates. The voltage on the capacitor may be sensed at a predetermined interval after the circuit is completed, or the circuit can respond to the time that it takes to charge the capacitor to a predetermined switching threshold, for example to develop a periodic signal with a time period that varies with capacitance. Time, period, voltage, current and related parameters can be used to cause the circuit elements to respond to the presence of liquid as sensed by a difference in capacitance, i.e., the sensed attributes or parameters being related to the capacitance of the plates 15 as affected by the dielectric constant of the material between the two conductive plates 15.

Inasmuch as the liquid 41 to be measured has a different dielectric constant than air, and displaces air (up to the level 9 of liquid between plates 15 as shown in FIG. 1), the measured voltage or other capacitance parameter provides an indication that changes as a function of level 9 of the measured material (liquid 41). The electrical circuit may be more or less complicated, for example including a simple oscillator with a time constant related to the capacitance to produce a variable frequency tone, or a complicated microprocessor that takes voltage/charge information from plural arrayed plate pairs and provides an output signal indicative of the measured capacitance parameter in a manner that perhaps is adjusted for other parameters.

The output signal developed is or may be converted to a sensory output signal in a form that can be perceived by the user. Sensory output signals, per se, include visible signals, sound signals such as beeps, tones, or a voice that enunciates words, or physical/mechanical signals such as vibration or movement of a tactile element. A piezo speaker, graphic or digital display, or a vibration motor may be used to create and provide such a sensory output signal, that is, an output signal for which activation, and perhaps a variably characteristic such as the signal level or another attribute, can be sensed by a user.

Advantageously in the case of visually impaired users, the sensory signal that is provided is perceivable by the user without using the sense of sight. Alternatively or in addition, the sensory output signal may be perceivable without the use of sight or hearing. A non-visual and/or non-auditory signal can of course be provided together with visual and/or auditory components for perception by others. Electrical component 37S may be such a signal converter that converts an electrical signal to a sensory output signal such as an audible signal or vibration. In one exemplary embodiment, electrical component 37S may be a piezo speaker. The sensory output signal provides information on the liquid level 9 and will vary as liquid level 9 changes.

Liquid 41 may be any of various liquids with various liquid properties. Although described as a liquid measuring device, the invention also can be used to measure the level of other materials that similarly seek a lowest level within a vessel, such as dry particulates, mixtures, aggregates and the like.

Materials that have a dielectric constant unequal to that of air can be introduced into a vessel configured as described, and can be sensed in the manner described. For example, other fluids, gels and syrups with varying viscosities may be measured according to the apparatus and method of the present invention. A wide range of materials with a dielectric constant different from air can be introduced into such a vessel and will flow or settle by gravity into a configuration with a relatively discrete upper level or at least a defined zone over which the material is adjacent to plates 15. Any such material level may be measured according to the method and apparatus of the invention. Various dry powders and granular materials may be so measured. Household examples include sugar, flour, chopped nuts, spices and the like.

The inventive liquid sensing apparatus can monitor a stationary liquid level 9 and emit or read out a level indication, or can provide a continuously variable indication of the current level of liquid or other material in cup 1 over a range of possible levels. In a further embodiment, the invention may incrementally or continually sense the presence of level or other material at successive threshold levels as the liquid level changes. The variable or multiple-threshold technique can be useful while cup 1 is being filled, e.g., by the user pouring or otherwise dispensing material into the cup, using the output of the device as an indication of the extent to which the cup 1 is filled or is approaching its full capacity.

The conductive plates 15 in the embodiment shown extend substantially to the lip 19 of cup 1, but any pre-determined level may be designated as the “filled” level or may provide a detection threshold indicated by activation or by a change in the sensory output signal. This aspect is useful for preventing overfilling and spillage.

The sensory output signal has a characteristic that is caused to vary as a function of the liquid level 9 in cup 1. In one embodiment, the sensory output signal may be a series of beeps, chirps, or other tones and the characteristic that is varied with liquid level 9 may be frequency. In this exemplary embodiment, a higher (or lower) liquid level 9 can be caused to provide higher (or lower) frequency of sounds. Another possibility is to use the beep repetition rate similarly as a variable characteristic. In an advantageous embodiment, the gap or silence between beeps can be reduced as the vessel is filled, and/or the duty cycle of the beep can be increased (more on-time and less off-time) until reaching a substantially continuous tone when the time liquid level 9 reaches a pre-determined threshold level. For example, a user filling the cup continues to fill as the frequency, beep repetition rate and/or duty cycle increases to a distinct characteristic (e.g., 100% on-time that indicates that the vessel is full).

Other signaling particulars can be used alternatively or in addition. The frequency of the tone used for the beep may increase. The tone may change to a certain point followed by a change in duty cycle, etc. A continuous tone or series of tones may be varied in volume as liquid level 9 increases.

In another possible embodiment, a recorded voice message may announce that the liquid level 9 has reached a detected threshold. The voice message may pass multiple thresholds, such as “one quarter full,” “half full,” “three quarters full,” “full.” The message may indicate a percentage to which the vessel is filled, e.g. “ten percent,” “twenty percent,” and so forth. This aspect can be correlated to a standard volume measure, for example announcing a fluid measure value such as “two ounces,” “four ounces,” “one cup,” “two cups,” and so on. If the sensory output is vibration, for example, the characteristic that varies with liquid level may be magnitude of vibration such that more vigorous or more continuous or other distinct vibration is associated with a higher liquid level or with reaching a threshold.

The particular nature of the signal, such as the foregoing examples of voice messages, beeps, tones, vibrations and the like, are intended to be exemplary of any sensory output signal having an aspect that is variable so as to be useful to indicate a changing condition, which according to the invention indicates a changing level in the vessel or the presence of liquid or other material at a given threshold level in cup 1.

For stagnant or dynamic liquid levels, measurements may be taken incrementally or substantially continuously when the apparatus is in the “on” condition. In one exemplary embodiment, once the electrical circuit is turned on, capacitance measurements may automatically be taken at a frequency of as much as 10 MHz, or at some other frequency that is convenient in view of the time constant of the capacitance of plates 15 and the resistance in series therewith.

The sensory output signals mentioned above are exemplary only, but it is advantageous that the signals be non-visual, i.e., signals that can be perceived by a user without the use of sight or at least without depending fully on the sense of vision. In another exemplary embodiment, the sensory output signals may be perceivable by a user without the use of sight or hearing, as in the tactile sensation of a vibrating signal.

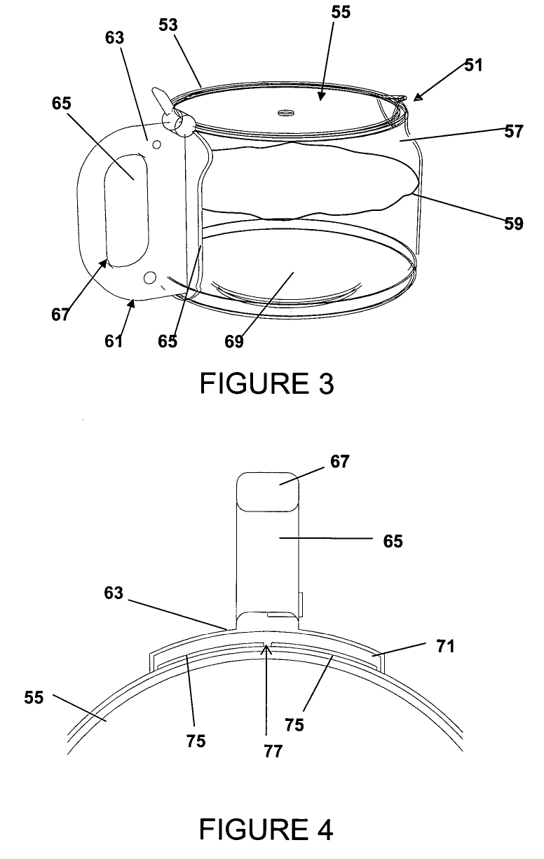

FIG. 3 shows another exemplary embodiment of the liquid sensing apparatus of the present invention in which the electronic components and electrical circuit is disposed within housing portion 63 of handle 61. The liquid carrying apparatus may be a carafe 51 such as used in conjunction with various conventional coffee makers, and is instrumented according to the invention. The shape and configuration of carafe 51 is exemplary only. The embodiment in which the electronic components are disposed within a housing portion of handle 61 may equally apply to other liquid containing vessels such as cups, pitchers, mugs, jugs, and so forth. Carafe 51 includes peripheral wall 53 that includes inner surface 55 and outer surface 57. Peripheral wall 53 may be formed of an insulating material. Glass may be used in one exemplary embodiment. Referring to both FIGS. 3 and 4, two conductive strips 75 are disposed on outer surface 57. Conductive strips 75 are insulated from one another and form the plates of a capacitor that is connected to electrical circuit 71, which includes components that combine to provide a sensory output signal, such as a vibration motor or speaker. Electrical circuit 71, including such components, is disposed within housing 63 of handle 61 and is as described in conjunction with FIGS. 1 and 2. Conductive strips 75 are covered by handle 61 which includes opening 65 and outer rib 67 and may be connected to conductive strips 75 and outer surface 57 using an adhesive 77 that is insulating in nature. A control button may be provided on or near handle 61 to turn on and off electrical circuit 71.

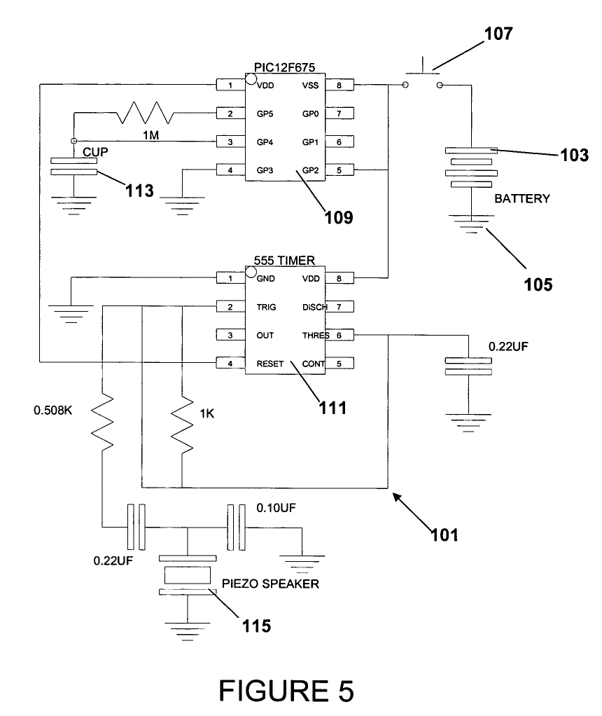

FIG. 5 is an exemplary circuit diagram of the electrical circuit of the present invention. Electrical circuit 101 includes battery 103 connected to ground 105. Electrical circuit 101 also includes on/off switch 107, microprocessor 109 and timer 111. Capacitor 113 is the capacitor formed of the two conductive plates formed on the liquid containing vessel according to the present invention. One side of capacitor 113 is connected to ground 105 while the other side is connected to a voltage or current source, battery 103, when on/off switch 107 is turned on. Other voltage or current sources may be used in other exemplary embodiments. Piezo speaker 115 converts the electrical signal to a sensory output signal which, in the present embodiment, is an audible signal. In other embodiments, piezo speaker 115 may be replaced by other components which convert electrical signals to other sensory output signals, such as a vibration motor, a solenoid-movable tactile signal pad, a visual display, etc.

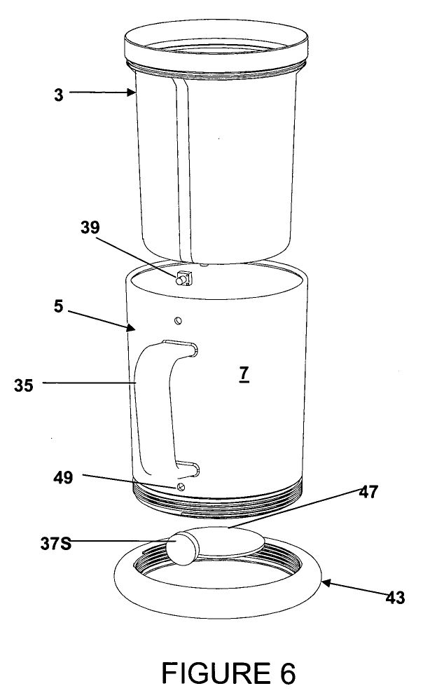

FIG. 6 is an exploded view of an exemplary liquid sensing apparatus of the present invention and includes inner wall 3 that defines a vessel bottom (not shown in FIG. 6). Outer wall 5 includes outer surface 7 and handle 35. Each of inner wall 3 and outer wall 5 in this example may be considered inner and outer sleeves. The electrical circuit includes circuit board 47 which may include various of the electronic component and piezo speaker 37S with improved audibility by virtue of hole 49 formed in outer wall 5. In an exemplary embodiment, piezo speaker 37S may be disposed flush against the inside of outer wall 5 to provide a water tight seal. Conventional devices such O-rings or other mechanical aids may be used to join separable components inner wall 3, outer wall 5 and base 43. In an exemplary embodiment, inner wall 3 may be joined to outer wall 5 and base 43 to form a water-tight seal. In this manner, electrical components 37 in the enclosure defined between the vessel wall portions, are isolated from water and the liquid containing vessel may be washed using conventional means. In another exemplary embodiment, base 43 may not be needed and inner wall 3 may essentially be an inner cup and outer wall 5 may essentially be an outer cup.

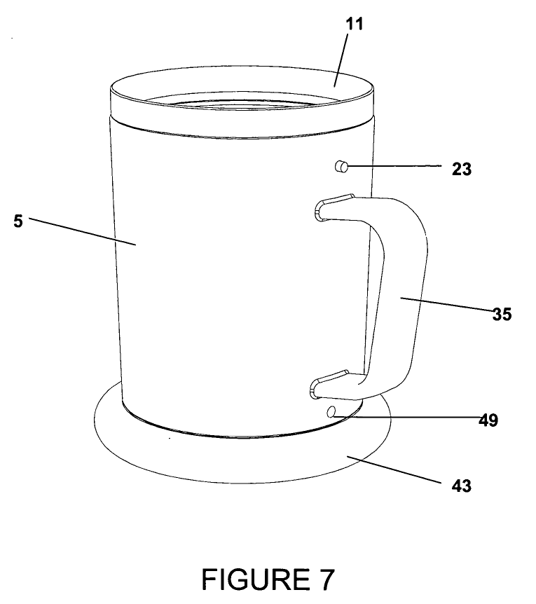

FIG. 7 shows an assembled version of the exemplary liquid sensing apparatus shown in FIG. 6 in exploded view.

The preceding discussion illustrates certain principles of the invention, and other principles will be understood to be inherent. Persons skilled in the art and aware of this disclosure can devise additional variations or arrangements that embody the principles of the invention and should be deemed to be included in the scope of the invention claimed.

Examples and conditional language as recited herein are principally intended for pedagogical purposes and to aid the reader in understanding the principles of the invention. Such examples and conditions should not be construed as limitations unless so stated or unless readily apparent in context. The invention also is intended to encompass not only the examples but also structural and functional equivalents to the extent permitted by law.

This description of exemplary embodiments should be read in connection with the accompanying drawings. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) normally refer to the orientation as then being described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A liquid sensing apparatus comprising a liquid containing vessel having an insulating inner surface, an outer surface and electronic components disposed between said insulating inner surface and said outer surface, said electronic components providing a sensory output indicative of a liquid level of a liquid within said liquid containing vessel.

2. The liquid sensing apparatus as in claim 1, wherein said electronic components include a capacitor comprising at least two conductive plates disposed adjacent to the insulating inner surface.

3. The liquid sensing apparatus as in claim 2, wherein said liquid containing apparatus includes a lip and a bottom and said conductive plates extend substantially from said lip to said bottom.

4. The liquid sensing apparatus as in claim 2, wherein at least one of said conductive plates extends beneath at least part of a bottom of said insulated inner surface.

5. The liquid sensing apparatus as in claim 1, wherein the electronic components provide said sensory output with at least one characteristic that varies as a function of said liquid level.

6. The liquid sensing apparatus as in claim 5, wherein said characteristic comprises at least one of amplitude, frequency, repetition rate and duty cycle.

7. The liquid sensing apparatus as in claim 1, in which said sensory output is perceptible by a changeable non-visual attribute.

8. The liquid sensing apparatus as in claim 1, wherein said sensory output is one of audible, vibratory and tactile.

9. The liquid sensing apparatus as in claim 5, wherein said sensory output assumes a distinct characteristic said liquid level is at or above a predetermined threshold liquid level.

10. The liquid sensing apparatus as in claim 9, wherein said sensory output achieve a continuous state when said liquid level is at or above the threshold liquid level.

11. The liquid sensing apparatus as in claim 1, wherein the sensory output is a voice annunciation respecting the liquid level.

12. The liquid sensing apparatus as in claim 1, wherein said liquid containing vessel comprises one of a cup, a pot, a jug, a pitcher, a carafe, and a measuring cup.

13. The liquid sensing apparatus as in claim 1, wherein said electronic components include a removable battery and said outer surface includes a door or plate for accessing said removable battery.

14. The liquid sensing apparatus as in claim 1, wherein said liquid containing vessel includes an insulating inner wall, an outer wall and a space therebetween, said insulating inner surface forming an external part of said inner wall and said outer surface forming an external part of said outer wall.

15. The liquid sensing apparatus as in claim 14, wherein said electronic components include a capacitor formed of at least two conductive plates disposed adjacent to an internal surface of said insulating inner wall, and wherein said electrical components are disposed within a hollow space between the inner wall and the outer wall.

16. A liquid sensing apparatus comprising a liquid containing vessel including a wall having an inner surface and an opposed outer surface and formed of an insulating material, a duality of conductive plates disposed on said outer surface and covered by a handle member permanently affixed to said liquid containing vessel and having electronic components therein, said electronic components including a capacitor formed of said duality of conductive plates and providing a sensory output indicative of a liquid level of a liquid within said liquid containing vessel.

17. A method for sensing liquid level comprising:
providing a liquid containing vessel having an insulating inner surface and an outer surface and electronic components disposed therebetween, said electronic components including at least two conductive plates of which at least one conductive plate is disposed between said inner surface and said outer surface in proximity with a volume of the vessel;
providing a liquid with a liquid level in said liquid containing vessel so as to at least partly occupy the volume, thereby affecting a capacitance value associated with the conductive plates, the capacitance varying with the liquid level;
sensing the capacitance that varies with said liquid level; and
providing a sensory output that is indicative of said liquid level, at least partly as a function of the capacitance parameter.

18. The method as in claim 17, wherein said providing a sensory output comprises providing a sensory output signal that is perceivable by a non-sighted user.

19. The method as in claim 18, wherein said providing a sensory output comprises providing a signal that varies as to at least one of amplitude, frequency, repetition rate and duty cycle as a function of at least one of a sensed capacitance within a range corresponding to a range of liquid levels, and a sensed capacitance corresponding to the liquid level reaching a predetermined threshold.

20. The method as in claim 19, wherein a continuous change of said liquid level produces a continuous change in the sensory output.
